(19) United States
(12) Patent Application Publication
(10) Pub. No.: US 2017/0009923 A1
(43) Pub. Date: Jan. 12, 2017

(54) Pipe Coupling

(71) Applicant: René Chavan, Boulens (CH)

(72) Inventor: René Chavan, Boulens (CH)

(21) Appl. No.: 15/120,525

(22) PCT Filed: Feb. 24, 2015
(86) PCT No.: PCT/IB2015/051362

§ 371 Date: Aug. 22, 2016

(30) Foreign Application Priority Data
Feb. 26, 2014 (IB) PCT/IB2014/059265

(51) Int. Cl. F16L 37/138; F16L 21/00

(52) U.S. Cl. CPC F16L 37/138; F16L 21/002

(57) ABSTRACT

The coupling for connecting an end of a first tubular member (12) to a part (13) comprises a sleeve (3), at least two bushings (2) said bushings being coupled to said tubular member by spreading means, compression means (4) acting on said bushings and able to compress said end of said first tubular member against said part through their coupling with the tubular member, wherein when said compression means compress said bushings, said bushings are moved away from said end of said first tubular member against an inner side of said sleeve by said spreading means.

### CORRESPONDING APPLICATION

The present application claims priority to earlier application N^{o} PCT/IB2014/059265 filed on Feb. 26, 2014 in the name of René Chavan, the content of this earlier application being incorporated by reference in its entirety in the present application.

### TECHNICAL FIELD

The present invention relates to a pipe coupling device and, more particularly, to a coupling system between tubular elements such as tubings, pipes and shafts for conveying fluids or vacuum pipeline systems connecting evacuated equipment and other similar products.

### BACKGROUND ART

Pipelines are needed for conveying fluids such as water, hydraulic oil, or liquefied gas such as liquid nitrogen, liquid helium. Other applications of pipelines include tubes and ducts connecting vacuum equipment, such as pipes used in vacuum pumping and processing systems. Further applications of pipelines requiring accurate pipe alignment and vacuum tightness include waveguides with circular cross section for low loss high frequency electromagnetic wave transmission over long distances.

The aforementioned applications of pipelines require high pressure liquid or gas, or low pressure vacuum tight connections between assembled pipe segments, capable of maintaining leak tightness and structural integrity at temperatures ranging from low cryogenic values to high vacuum baking temperatures or temperatures required for lowering the viscosity of fluids.

According to the prior art, pipes are usually joined and sealed by means of welding, axial compression flanges, or radial compression clamping sleeve couplings in combination with gaskets and other sealing means. Pipe couplings are usually known to employ a fitting sleeve that covers both pipe or tubing ends, or the pipe/tubing end and a connecting piece, with the aim to compress the axial or radial seal while allowing for limited axial or radial movement of the adjacent parts.

### DISCLOSURE OF INVENTION

### Technical Problem

A most common feature to all types of pipe couplings using axial or radial gaskets or radial fitting rings to achieve pressure or vacuum tightness is that the radial or axial compression of the seal and the compensation of the axial thrust generated by hydrostatic pressure in the pipe results by design in high radial and tangential pipe loads, which tend to deform and stress the pipe cross section by constriction or bending to amounts not tolerable either for the pipe material or in applications where the pipe geometry is important. To counter an excessive deformation of the pipe ends, it is common to reinforce the pipe and/or the coupling with flanges, liners or sleeves. The numerous additional parts in such a radial compression type pipe joint increase its volume and mass, and make it expensive to produce. These difficulties are exacerbated when pipes and pipe couplings made of materials of low mechanical strength are to be used for economical or application specific reasons, such as aluminium or copper pipes for high electrical conductivity as an example.

In a number of applications, for the highest effectiveness of a pipeline, it is desirable that the pipe coupling and sealing system form a completely continuous pipe wall with constant cross section and best possible axial alignment of the pipe ends, contribute minimally to detrimental internal trapped or dead volumes and maintain structural and functional integrity under external loads. Common coupling methods for these applications include flanged systems, such as those according to ISO 3669 and DIN EN 1092, flanged clamps with axially retaining rings, or ISO-KF and ISO-CF, such as those according to ISO 1609, and couplings using a variety of V-shaped clamps or collars over tapered flanges, such as those according to ISO 2861.

Furthermore, in safety critical cryogenic and ultra-high vacuum applications, or very high temperature applications, metallic seals are used between the mating ends of the pipes, requiring a well defined axial compression and a very high compression force compared with elastomeric gaskets. Metal seals must be protected from even small surface defects during the assembly and tightening phases.

### Technical Solution

The disadvantages commonly encountered with pipe couplings according to the prior art can be overcome by the present invention, illustrated in FIG. 7.

The object of the invention is to provide an improved coupling. In particular, an aim of the present invention is to provide a coupling which is actually suitable for use with metallic gaskets requiring high to very high axial compression forces between the faces of the pipe ends while avoiding unacceptable radial deformation of the pipe ends. The object is achieved by the fact that interlocking, concentric parts comprise conjugate wedge shaped circumferential grooves which have an asymmetrical cross-section with respect to a radial plane with a relatively steeply slanting flank towards the sealing pipe faces and a relatively gently slanting flank away from the pipe faces. When an axial force is applied towards the sealing pipe faces simultaneously to split bushings, having wedge shaped circumferential grooves on their inner diameter, the segments of the bushings are expanded outwards against the steeply slanted flanks of the grooves around the pipe ends and set against the inner cylindrical surface of an axially and radially stiff housing sleeve. The magnitude of radial expansion of the split bushings is essentially limited by the difference of the outer diameter of the bushings and the inner diameter of the coupling sleeve, the difference preferably being of the order of 0.5% to 3% of the diameter of the sleeve bore. The axial forces against the pipe ends compress the gaskets while the bushings slide along the bore of the housing sleeve, until the pipe ends reach their respective axial positions at face contact.

The axial forces required to axially compress the pipe ends are generated by a set of threaded pins located in one of the collars withheld by retaining rings in the coupling sleeve. The tightening moment applied to the threaded pins predominantly determines the axial preload force applied to one or more gaskets.

The wedge shaped grooves have gently and steeply slanted flanks, the gently slanted flanks preferably having an angle between 45° and 80° between the plane perpendicular to the pipe axis and the slanted flank, and the steeply slanted flanks preferably having an angle of preferably less than 45° and more than 5° between the plane perpendicular to the pipe axis and the slanted flank. The most preferred angle of the steeply slanted flank is one of approximately 20°, forming a tapered geometry centered on the pipe axis and having an aperture of approximately 140° towards the sealing pipe faces. Of course, other angles values may be chosen, for example between 0° and 90° according to circumstances.

With such a shape of the interlocking forms, the transmission of axial compression forces between pipe sections and the coupling occurs over a large surface composed of the multiple slanted profiled contact sections. As the contact surface between pipe ends is of approximately the same diameter as the grooves, the sealing end faces are virtually free from transverse moments, such as those occurring in most flanged couplings, in which the preloading bolts under tensile stress are radially offset outwards from the gasket perimeter.

The radial components of the axial reaction forces against the wedge shaped grooves are small and may vary as a function of the friction angles and the angle of the slanted flank.

According to a first aspect of the present invention there is provided a coupling system between first and second tubular members comprising:

a first tubular member having a first end which includes a first profiled section extending circumferentially and continuously around an outer surface;

the face of the first end of the first tubular member which includes either a profile acting as the first part of a compression lip seal or welded seal or one or more concentric grooves accommodating one or more gaskets;

a second tubular member having a first end which includes a first profiled section extending circumferentially and continuously around an outer surface;

the face of the first end of the second tubular member being preferably flat or which includes a profile acting as a second part of a compression lip seal or welded seal;

Preferably the first and the second tubular members have the same outer diameter and inner diameter.

### Advantageous Effects

The invention provides for a positive-locking (form-fit) pipe coupling system for highest safety requirements, while allowing multiple assembly and disassembly procedures.

The invention further provides a self centering feature to the pipe ends by means of the coaxially slanted flanks of the bushings and the pipe ends. The assembly process is, however, facilitated with the use of an axially floating centering ring remaining in place once the coupling is assembled.

Another aspect of the invention provides for a pipe coupling system which includes a coupling sleeve in a determined position with fixed dimensions, making the coupling system suitable for fluid or vacuum tight wall feed-through applications. For example, the tubular coupling sleeve may have a circular or prismatic outer cross section and thus may be part of a building structure.

In accordance with still another aspect of this invention there is provided a coupling system in which the pipe ends may have any orientation along their axis of symmetry as the couplings components are preferably axially symmetric too.

Further features of this invention are the possibility of using low strength materials for the pipes, such as copper, aluminium or industrial plastics. The tightness and pressure rating of the coupling is solely determined by the limits to the contact stress between the pipe ends and the gasket materials, as mechanical stresses in the other parts of the coupling are always lower.

In one embodiment, the invention concerns a pipe coupling for connecting an end of a first tubular member to a part, said coupling comprising a sleeve, at least two bushings, said bushings being coupled to said tubular member by spreading means, compression means acting on said bushings and able to compress said end of said first tubular member against said part through their coupling with the tubular member, wherein when said compression means compress said bushings, said bushings are moved away from said end of said first tubular member against an inner side of said sleeve by said spreading means.

In one embodiment the part is a second tubular member.

In one embodiment, the part is a container or another product to which the tubular member is to be connected.

In one embodiment, the sleeve is formed by a receiving bore of part.

In one embodiment, the sleeve is formed by a flanged housing sleeve.

In one embodiment the end of the tubular member or at least one end of the tubular members comprises at least one concentric groove for retaining a gasket.

In one embodiment said end of said tubular member or at least one end of said tubular members comprises two concentric grooves, each for retaining a gasket or each end comprises at least one concentric groove for retaining a gasket. Said gasket may be a metallic gasket or another gasket.

In one embodiment, the coupling comprises a spacer and gasket ring with a gasket between the end and the part.

In one embodiment, the bushings are made of at least two shells. Preferably, the bushings are made of three shells. The bushings may be made of a single piece as well, allowing for radial outward expansion, if this practical in the context of the application of the invention.

In one embodiment, the spreading means comprise a least one wedge shaped circumferential groove placed on an outer surface of said ends and an inner surface of said bushings. Other spreading means may be envisaged in the frame of the present invention, for example ramps, elements have a variable size depending on the pressure they are subjected to, adjustable means, such as screws etc.

In one embodiment, the spreading means may comprise a plurality of wedge shaped circumferential grooves placed in the bushings and on the tubular members.

In one embodiment, the wedge shaped circumferential grooves may have an asymmetrical cross-section with respect to a radial plane.

In one embodiment, the asymmetrical cross-section is formed by a substantially steep slanting flank toward the end of the members and a substantially gently slanting flank away from the end of the members.

In one embodiment, the compression means comprise two adjustable collars attached in the sleeve. Other compression means may be envisaged in the frame of the present invention, such as screws or threaded caps.

In one embodiment, the collars are maintained in the sleeve via removable retaining rings.

In one embodiment, at least one of the collars comprises a plurality of threaded pins for adjustment of the compression force of both collars on the bushings.

In one embodiment, the pipe coupling further comprises a centering ring for aligning the ends of the tubular members.

In one embodiment, the pipe coupling further comprises washers for providing an axial preload.

In one embodiment, the invention concerns a pipe system comprising at least one pipe coupling as defined in the present application.

In one embodiment, the invention concerns a coupling method for pipes using a pipe coupling or system as defined in the present application.

### BRIEF DESCRIPTION OF DRAWINGS

These and other features of the invention will become apparent from the following description of one embodiment of the invention, by way of examples only, with reference to the drawings in which :

FIG. 1 shows a perspective view of the unaligned gasket and centering parts in preparation of the first step of the assembly process;

FIG. 2 shows a perspective view of the prealigned pipe ends assembly;

FIG. 3 a perspective view of the split bushings and the collars in preparation of the second step of the assembly process;

FIG. 4 a perspective view of the preassembly within the housing sleeve;

FIG. 5 a perspective view of the retaining rings and the threaded pins in preparation of the last step of the assembly process;

FIG. 6 a perspective view of the completely assembled pipe coupling;

FIG. 7 a perspective section view of the pipe coupling;

FIG. 8 a section view of the pipe coupling;

FIG. 9 a detail of the section view of the assembled pipe coupling;

FIG. 10 a detail of the section view of the first step of assembly;

FIG. 11 a detail of the section view of the second step of assembly;

FIG. 12 a detail of the transverse section view of the second step of assembly;

FIG. 13 a detail of the section view of the third step of assembly;

FIG. 14 a detail of the transverse section view of the third step of assembly;

FIG. 15 a detail of the section view of the fourth step of assembly;

FIG. 16 a detail of the section view of the fifth step of assembly;

FIG. 17 a detail of the section view of the sixth step of assembly;

FIG. 18 a detail of the transverse section view of the sixth step of assembly;

FIG. 19 shows a section view of the coupling of two pipelines;

FIG. 20 shows a section view of the coupling of two pipelines without gasket;

FIG. 21 shows a section view of the connection of a pipeline to a container with a receiving bore;

FIG. 22 shows a section view of the connection of a pipeline to a container with a flat wall;

FIG. 23 shows a section view of the coupling of two pipelines;

FIG. 24 shows a perspective view of the coupling of two pipelines.

### DETAILED DESCRIPTION OF THE DRAWINGS

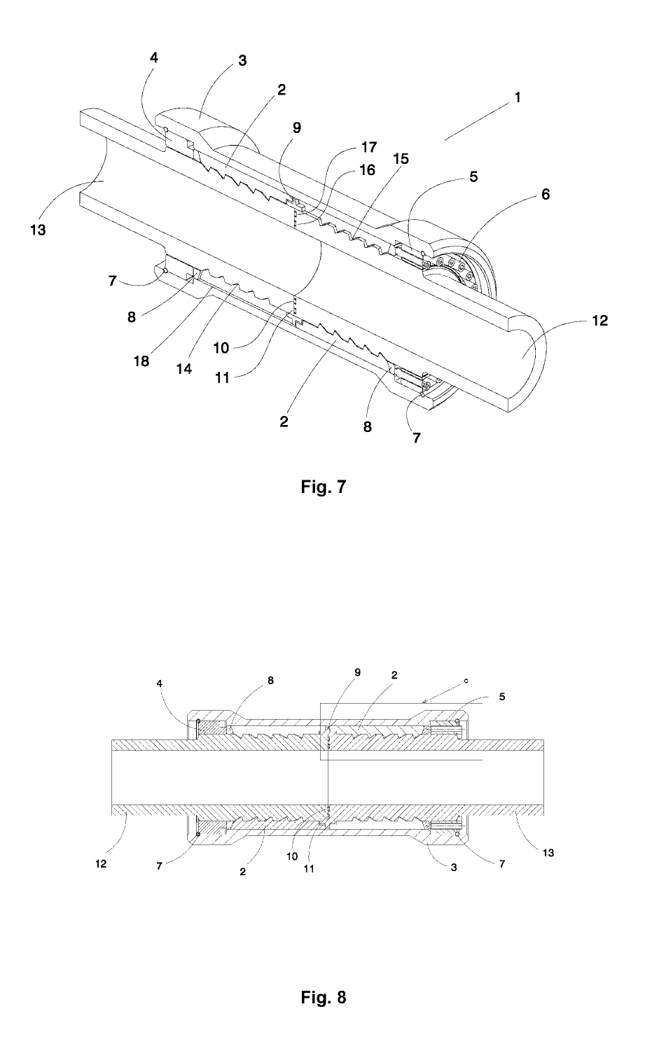

Referring to the drawings, a pipe coupling tightly joining two inserted pipe elements 12 and 13 is shown in FIG. 7 which illustrates the principle of the invention.

More specifically, the present invention relates to a pipe coupling 1, represented in FIG. 7, comprising an axially and radially stiff housing sleeve 3, having a cylindrical bore 18 for accommodating each end of the two inserted pipe elements 12 and 13, both featuring end sections with axially distributed wedge shaped grooves 14 on the outer diameter, and one of the inserted pipe elements (or both) having one or more concentric grooves 16 and 17 for retaining one or more gaskets 10 and 11, and which allow the insertion of two sets of axially split, cylindrically shaped bushings 2 with a slightly expanded conjugate wedge shaped profile 15 on their inner diameter, which are each axially constrained by axially inserted collars 4 and 5 maintained captive along the inner diameter of the housing sleeve 3 by a retaining ring 7, with one collar 5 bearing threaded pins 6 in contact with a washer 8 for providing the axial preload of the complete coupling 1 required for the radial outward expansion of the split bushings 2 against the housing sleeve bore 18.

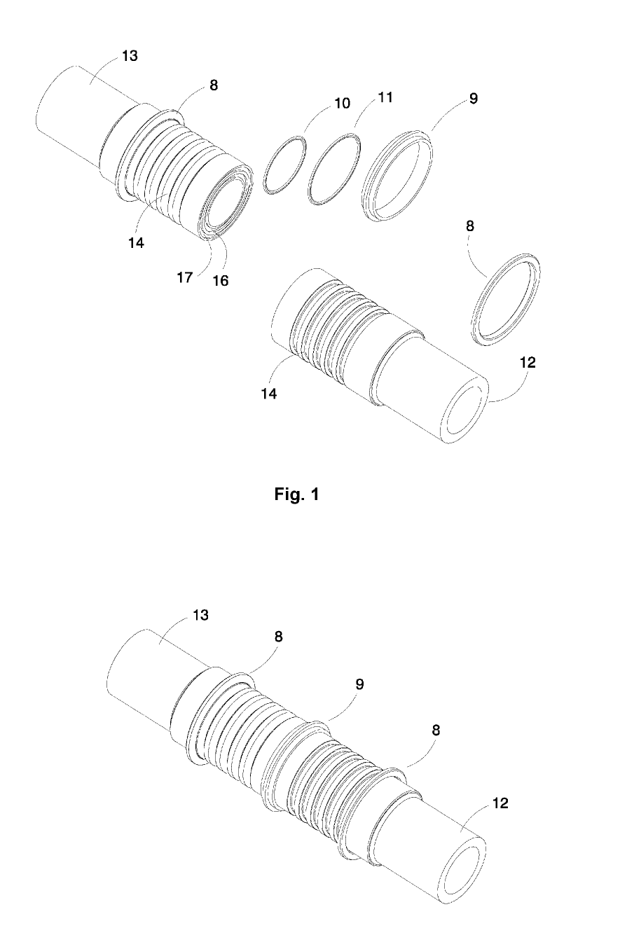

A view of the unaligned gaskets 10 and 11, a centering ring 9 and washers 8 in preparation of the first step of the assembly process is shown in FIG. 1. The appropriate alignment of these parts prior to assembly is represented in the detailed section view in FIG. 10 (detail).

The achieved insertion of the washers 8 on the respective pipe elements 12 and 13 and the insertion of the gaskets 10 and 11 into the concentric face oriented grooves 16 and 17 is shown in FIG. 2. Here the centering ring 9 is shown as an auxiliary item to maintain good coaxiality of the two pipe elements during the assembly process and protect the gaskets. The coupling however may also be assembled and used without such ring 9.

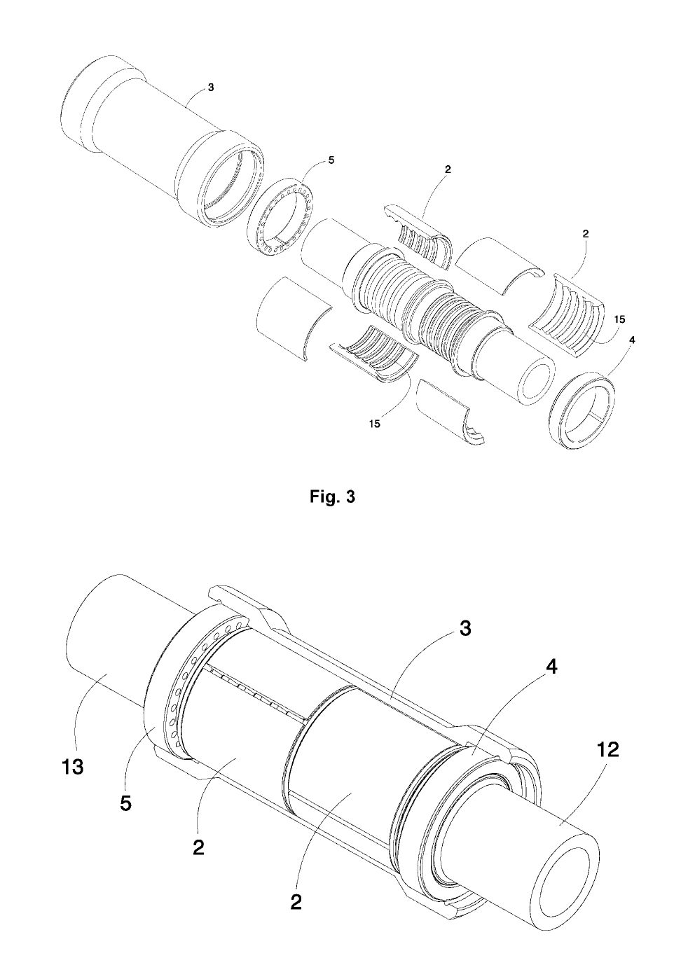

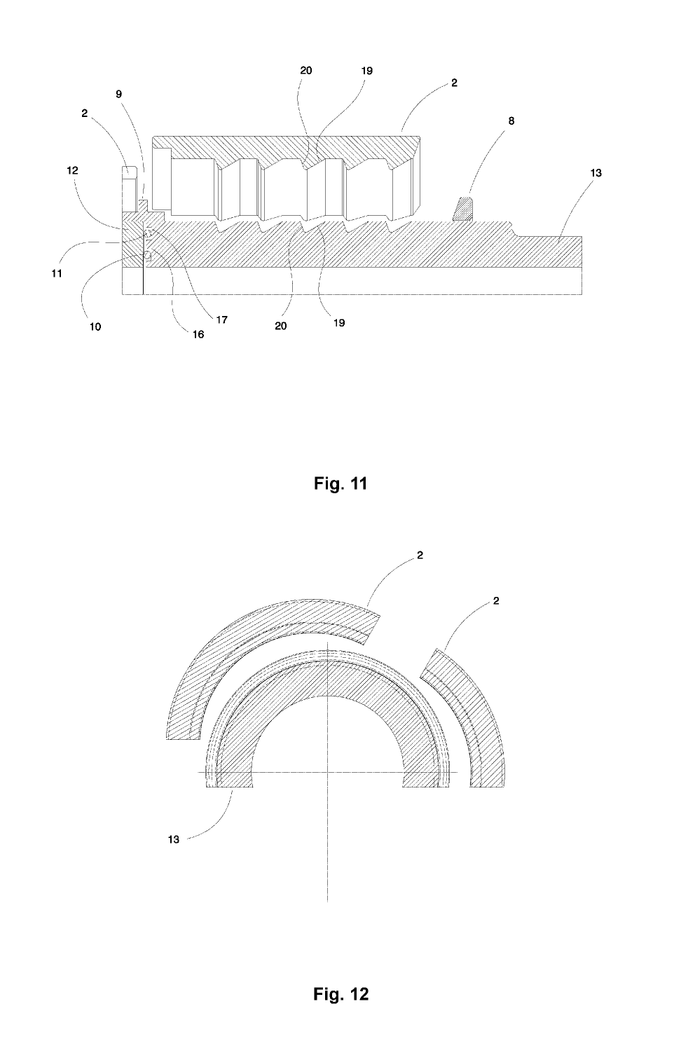

In FIG. 3 the collars 4 and 5 and the coupling housing sleeve 3 are inserted in their respective order from one open end of the assembled pipe elements. The two split bushings 2 are positioned around the pipe elements 12 and 13 with the wedge shaped grooves in the pipe elements 14 and the bushings 15 facing each other. The appropriate alignment of these parts and the apposition of the bushings during the assembly process is represented in the detailed section view in FIG. 11 and in a transverse section in FIG. 12.

The yet loose pipe coupling preassembly is represented in FIG. 4, where the housing sleeve 3 is shown in a section cut to visualise the randomly oriented position of the bushings 2 relative to each other. The collars 4 and 5 are seated with the cylindrical bore 18 of the housing sleeve 3.

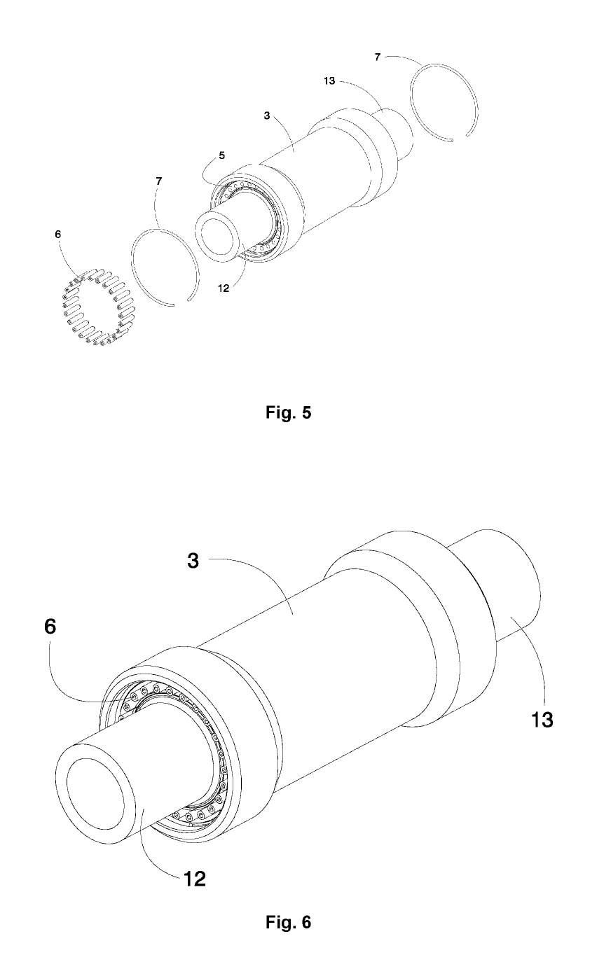

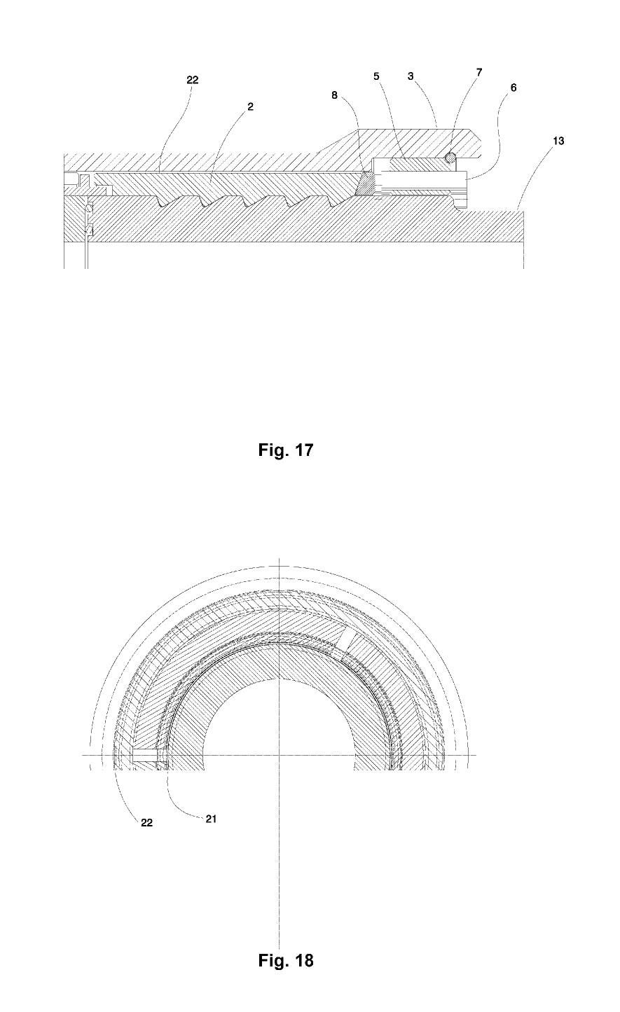

The last step of the assembly process is depicted in FIG. 5, where the retaining rings 7 and the threaded pins 6 are added. The details of this assembly step are represented in FIG. 16 and FIG. 17. The still open radial gap 22 between outer diameter of the split bushings 2 and the cylindrical bore 18 of the housing sleeve 3 allows the housing sleeve to be axially positioned and the retaining rings 7 and the threaded pins 6 be inserted. In FIG. 17, the retaining rings 7 and the threaded pins 6 are in their respective positions, but the threaded pins 6 are not yet tightened.

After tightening the threaded pins 6 to their required preload, the complete pipe coupling is shown assembled in FIG. 6.

In the embodiment shown in the section view in FIG. 8, the coupling is assembled.

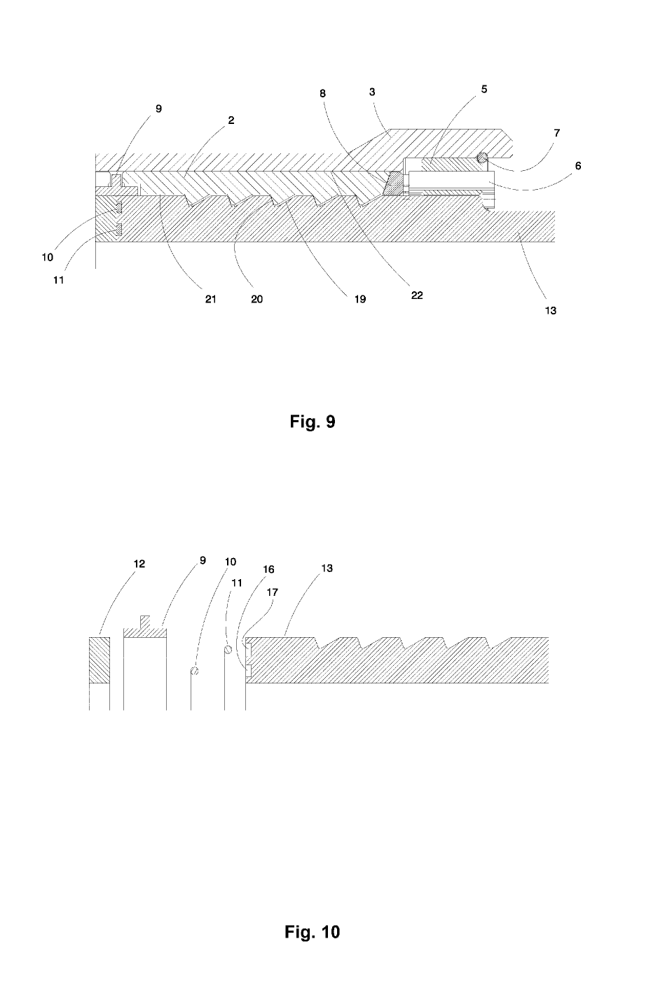

FIG. 9 represents a detailed view of the section of the assembled coupling showing the interlocking wedge shaped profiles with the gently slanted groove flank 19 and the steeply slanted groove flank 20. FIG. 18 represents the transverse section of the assembled coupling. By the action of the axial force applied by the threaded pins 6 on the washers 8 and the bushings 2, the bushings 2 are expanded outwards by sliding on the steeply slanted groove flanks 20 of the pipe elements 12 and 13, thus closing the radial gap 22 between outer diameter of the split bushings 2 and the cylindrical bore 18 of the housing sleeve 3 and opening the radial gap 21 between outer pipe elements 12 and 13 end section diameter and the inner diameter of the split bushings 2.

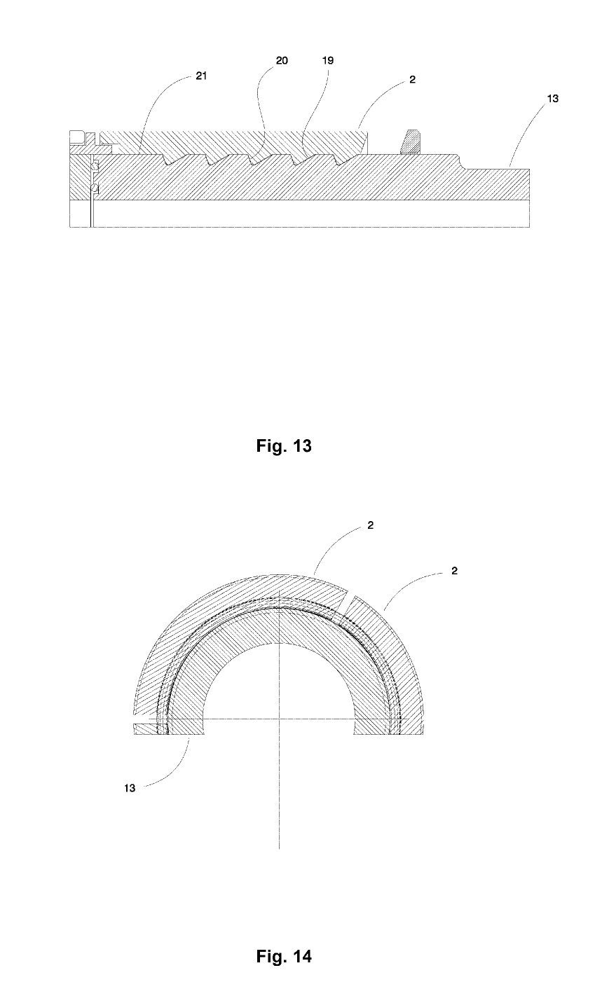

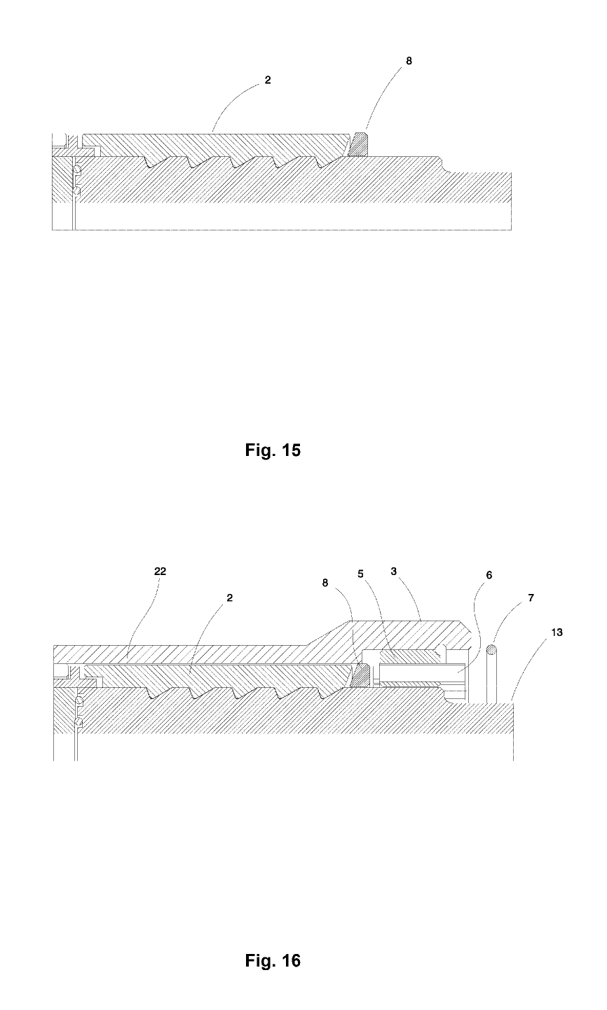

With the pipe elements 12 and 13 held in place, the split bushing 2 are set in contact with the mating outer pipe elements 12 and 13 and positioned together with the washers 8, as shown in FIG. 13, FIG. 14 and FIG. 15. The radial position of the bushings 2 is determined by the radial gap between outer pipe elements 12 and 13 end section diameter and the inner diameter of the split bushings 2.

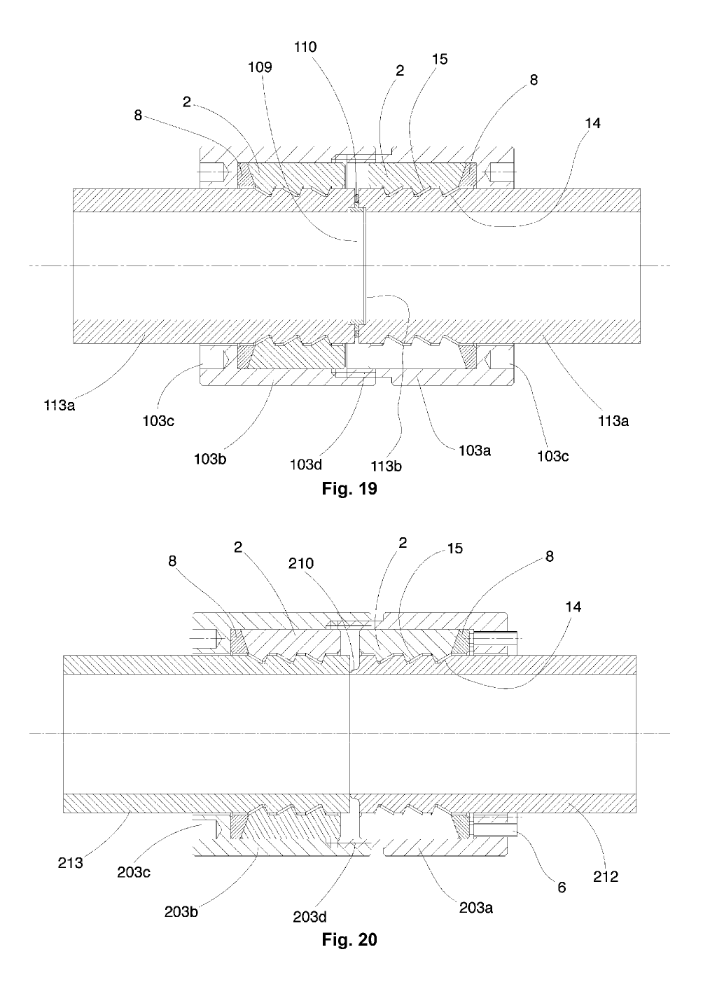

FIG. 19 shows as one of the preferred embodiments a longitudinal section of a space saving pipe connection, wherein the pipe elements 113a have flat contact faces to accommodate a gasket 110 and grooves 113b for relative centering by a ring 109 simultaneously acting as a spacer, limiting gasket compression to its appropriate amount. The axial gasket compression force and the centering of the pipes 113a are the results of the expansion of the split bushings 2 with wedge shaped grooves 15, against the wedge shaped grooves 14 of the pipe element 113a, obtained by applying opposing tightening moments to both threaded 103d housing sleeves 103a and 103b, using suitable tools, such as a caliper face spanner (similar to DIN 3116) or a hook wrench (similar to DIN 1810). This embodiment allows an easy coupling of both sleeves 103a and 103b via the thread 103d.

FIG. 20 shows a section view of an example of the coupling of two pipelines 212 and 213 without gasket, in which the compression of the precision machined sealing rim 210 against the flat end of pipe 213 achieves pressure or vacuum tightness. Such pipe couplings require a high axial compression force, which is generated by a set of threaded pins 6, analogously to the representation in FIG. 9. Assembly of the coupling is simplified by using threaded housing sleeves 203a and 203b which are mated via thread 203d. Reference 203c illustrates the bores used for tightening the threaded housing sleeves 203a and 203b with a tool (not illustrated).

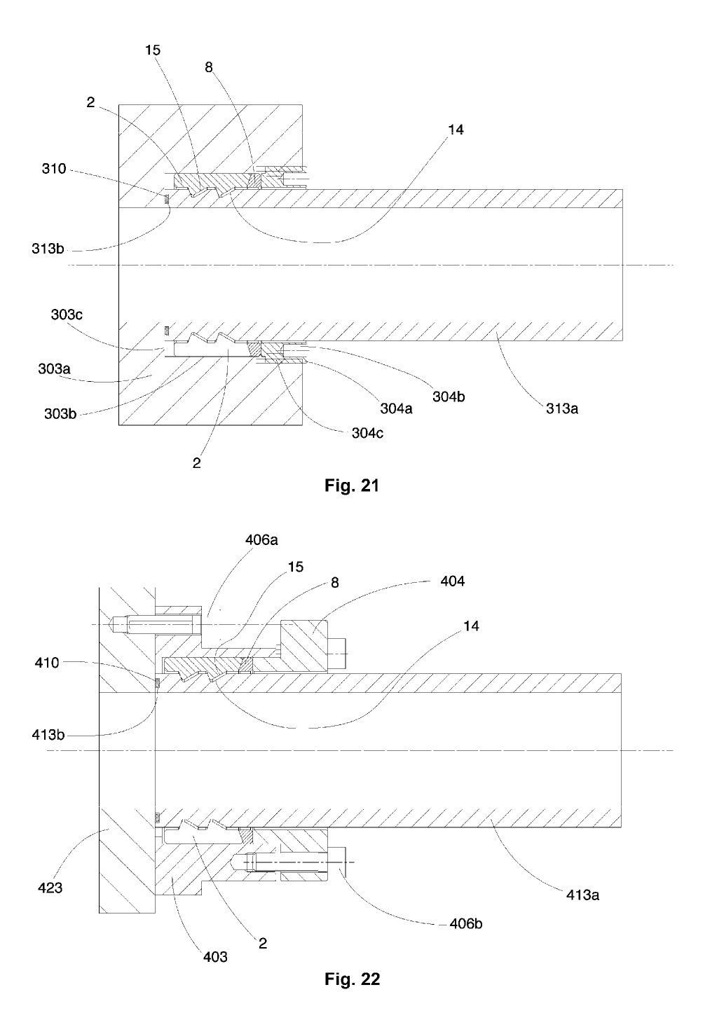

FIG. 21 shows a section view of an embodiment of the connection of a pipeline 313a to a container 303a, with a receiving bore 303b, having a flat bottom contact surface 303c. While the exemplary embodiment shown in FIG. 8 comprises two concentric gaskets, in this application only one gasket 310 in a single radial groove 313b is required. Of course, additional gaskets may be used as well. In this embodiment, a split bushing 2 with a smaller number of wedge shaped grooves 14 and 15 may be used. Of course, it is also possible to use a bushing with more than the illustrated number of grooves as well, in accordance with the present invention, for example to reduce the load on individual grooves. Of course, this is only an example and the container 303a may be any suitable product to which a pipe is connected. 304a illustrates a threaded collar, 304b illustrates bores for tightening the threaded collar 304a against the container 303a with a tool and 304c illustrates a thread of container 303a. According to the principles of the present invention the threaded collar 304a is used to apply the proper compression in the connection between the pipe 313a and the container 303a on the gasket 310.

FIG. 22 shows a section view of an embodiment of the connection of a pipeline 413a to a container 423 with a flat wall. In this embodiment, the housing sleeve 403 is flanged against the container wall 423 with a number of bolts 406a. The axial compression force of the gasket is generated by tightening the bolts 406b distributed around the flange of the collar 404. 410 illustrates a gasket and 413b a groove for the gasket. The functioning of this embodiment is similar to the preceding one in application of the principles of the present invention.

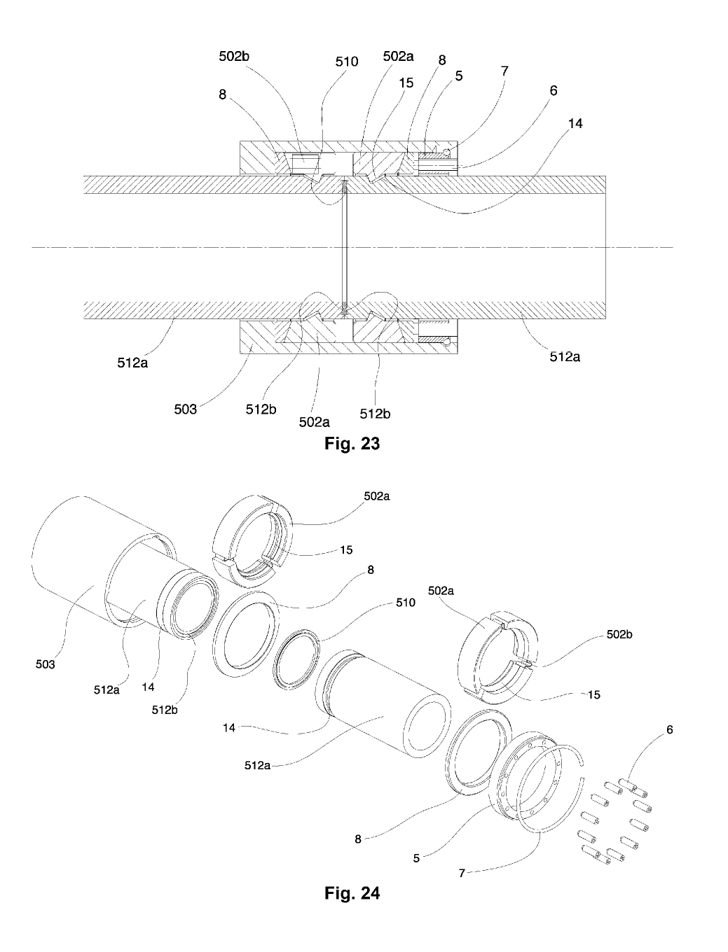

FIG. 23 shows a section view of an embodiment of the connection of two pipelines 512a, sealed by compression of a ductile metallic or non-metallic gasket 510. The faces in contact with the gasket 510 of the pipe elements 512a feature knife edges 512b, with a geometry according to ISO 3669-2 or similar, deforming the gasket 510 during the compression of the coupling assembly by tightening the threaded pins 6. In this embodiment, the split bushings 502a, illustrated with one row of wedge shaped grooves 15, are circumferentially joined by a flexible link 502b to facilitate the assembly of the coupling. Other configurations of split bushings as illustrated in the present application may be used.

FIG. 24 illustrates the embodiment of FIG. 23 in a perspective view of the coupling parts prepared for assembly. In this embodiment, three segments of the split bushings 502a are joined by flexible links 502b, allowing the grooves 15 of the two sets of split bushings 502a to remain captive in the grooves 14 of the pipe elements 512a to facilitate the assembly process.

The embodiments described in the present application are examples that should not be considered in a limiting manner. They may be combined together according to circumstances and the result to be achieved. Many variations are possible in the frame of the present invention, also by the use of equivalent means. The application of the present invention is not limited to the examples disclosed but it may be used in many different fields where a tube is connected to another tube or to another device (such as a container or other).

### REFERENCES

ISO 1609 Vacuum technology—flange dimensions.

ISO 2861 Vacuum technology—quick release couplings.

ISO 3669 Vacuum technology—bakable flanges.

DIN EN 1092 Flanges and their joints

DIN 2695 Weld ring seals for flange connections

Clamp Sleeve Coupling, C. H. Zikesch Armaturentechnik GmbH, D-46485 Wesel

WO 2013/120201 Patent

U.S. Pat. No. 5,413,388 Patent

WO 2007/069216 Patent

EP 1078196 B1 Patent

KR 20030090617 A Patent

### REFERENCE NUMBERS

(1) pipe coupling, complete
(2) split bushings
(3) housing sleeve
(4) collar, loose
(5) collar, loose, with crown of threaded holes for insertion of threaded pins (6)
(6) threaded pin
(7) retaining ring
(8) washer, with a cone at one face and a plane face
(9) centering ring
(10) gasket, with small diameter
(11) gasket, with large diameter
(12) pipe element
(13) pipe element, with concentric grooves (16) and (17)
(14) wedge shaped grooves, peripheral in pipe element
(15) wedge shaped grooves, internal in bushings
(16) concentric groove, with small diameter
(17) concentric groove, with large diameter
(18) cylindrical bore, of the housing sleeve (3)
(19) gently slanted groove flank
(20) steeply slanted groove flank
(21) radial gap between outer pipe elements (12) and (13) end section diameter and the inner diameter of the split bushings (2)
(22) radial gap between outer diameter of the split bushings (2) and the cylindrical bore (18) of the housing sleeve (3)
(103a) threaded housing sleeve (male)
(103b) threaded housing sleeve (female)
(103c) bores for tightening the threaded housing sleeves 103a and 103b with a tool
(103d) thread of the housing sleeves 103a and 103b
(109) spacer and gasket centering ring
(110) gasket
(113a) pipe element
(131b) concentric groove, for gasket centering ring 109
(203a) threaded housing sleeve (male)
(203b) threaded housing sleeve (female)
(203c) bores for tightening the threaded housing sleeves 203a and 203b with a tool
(203d) thread of the housing sleeves 203a and 203b
(210) sealing rim of pipe element 212
(212) pipe element, with integrated sealing rim
(213) pipe element, with plane end face
(303a) container, cut-out of wall section
(303b) receiving bore
(303c) flat bottom contact surface
(304a) threaded collar
(304b) bores for tightening the threaded collar 304a against the container 303a with a tool
(304c) thread of container 303 and threaded collar 304
(310) gasket
(313a) pipe element with a groove 313a
(313b) concentric groove, for gasket 310
(403) flanged housing sleeve
(404) flanged collar
(406a) bolts for tightening the flanged housing sleeve 403
(406b) bolts for tightening collar 404
(410) gasket
(413a) pipe element with a groove 413b
(413b) concentric groove, for gasket 410
(423) container, with a flat wall
(502a) split bushing
(502b) flexible link between split bushings segments
(503) housing sleeve
(510) metal gasket, geometry according to ISO 3669-2 or similar
(512a) pipe element with a knife edge 512a
(512b) knife-edge at the pipe element sealing face, geometry according to ISO 3669-2 or similar

1-20. (canceled)

21. A pipe coupling for connecting an end of a first tubular member to a part, the pipe coupling comprising:
a sleeve;
at least two bushings, the bushings being coupled to the first tubular member by spreading means; and
a compression device that acts on the bushings and is configured to compress the end of the first tubular member against the part through a coupling with the first tubular member;
wherein the bushings and the sleeve are configured such that when the compression device compresses the bushings, the bushings are moved away from the end of the first tubular member against an inner side of the sleeve by the spreading means.

22. The pipe coupling as defined in claim 21, wherein the part includes a second tubular member.

23. The pipe coupling as defined in claim 21, wherein the part includes a container.

24. The pipe coupling as defined in claim 21, wherein the sleeve is formed by a receiving bore of the part.

25. The pipe coupling as defined in claim 23, wherein the sleeve is formed by a flanged housing sleeve.

26. The pipe coupling as defined in claim 21, wherein the end of the first tubular member includes a concentric groove configured to retain a gasket.

27. The pipe coupling as defined in claim 21, wherein the end of the first tubular member includes two concentric grooves, each of the two concentric grooves configured to retain a gasket, or each end of the first tubular member including at least one concentric groove configured to retain a gasket.

28. The pipe coupling as defined in claim 21, further comprising:
a spacer and gasket centering ring with a gasket arranged between the end of the first tubular member and the part.

29. The pipe coupling as defined in claim 21, wherein each of the at least two bushings are made of at least two shells.

30. The pipe coupling as defined in claim 21, wherein the spreading means includes a wedge-shaped circumferential groove placed on an outer surface of the end of the first tubular member and an inner surface of the at least two bushings.

31. The pipe coupling as defined in claim 21, wherein the spreading means includes a plurality of wedge-shaped circumferential grooves.

32. The pipe coupling as defined in claim 30, wherein the wedge-shaped circumferential groove has an asymmetrical cross-section with respect to a radial plane.

33. The pipe coupling as defined in claim 32, wherein the asymmetrical cross-section is formed by a substantially steep slanting flank towards the end of the first tubular member and a substantially gently slanting flank away from the end of the first tubular member.

34. The pipe coupling as defined in claim 21, wherein the compression device includes two adjustable collars attached in the sleeve.

35. The pipe coupling as defined in claim 34, wherein the two adjustable collars are attached in the sleeve via a removable retaining ring.

36. The pipe coupling as defined in claim 34, wherein at least one of the collars includes a plurality of threaded pins for adjusting a compression force on the bushings of the at least one of the collars.

37. The pipe coupling as defined in claim 22, further comprising:
a centering ring for aligning the end of the first tubular member and an end of the second tubular member.

38. The pipe coupling as defined in claim 21, further comprising:
washers for providing an axial preload.

39. A pipe system comprising:
a first tubular member;
a second tubular member; and
a pipe coupling for connecting an end of the first tubular member with an end of the second tubular member, the pipe coupling including,
a sleeve,
at least two bushings, the bushings being coupled to the first tubular member by spreading means, and
a compression device that acts on the bushings and is configured to compress the end of the first tubular member against the second tubular member through a coupling with the first tubular member;
wherein the bushings and the sleeve are configured such that when the compression device compresses the bushings, the bushings are moved away from the end of the first tubular member against an inner side of the sleeve by the spreading means.

40. A coupling method between a first pipe and a second pipe using a pipe coupling, the pipe coupling including a sleeve, two bushings, the two bushings being coupled to the first pipe by spreading means, and a compression device that acts on the two bushings and is configured to compress an end of the first pipe against the second pipe through a coupling with the first pipe, the method comprising the steps of:
compressing the two bushings with the compression device; and
moving the two bushings away from the end of the first pipe against an inner side of the sleeve by the spreading means, with the step of compressing.
